(19) United States
(12) Patent Application Publication
(10) Pub. No.: US 2003/0168510 A1
(43) Pub. Date: Sep. 11, 2003

(54) Anonymous electronic bearer instrument method and apparatus

(76) Inventor: R. Kendall Allen, McLean, VA (US)

Correspondence Address: BRADFORD E. KILE (REG. 25,223), KILE GOEKJIAN LERNER & REED PLLC, 655 15TH STREET, NW, SUITE 475A, WASHINGTON, DC, 20005, US

(21) Appl. No.: 09/985,100

(22) Filed: Nov. 1, 2001

(51) Int. Cl. G06K 5/00

(52) U.S. Cl. 235/380

(57) ABSTRACT

A method and apparatus for transacting for at least one of currency, goods or services with an anonymous electronic bearer instrument which is created or incremented by a vendor in exchange for currency tendered by an anonymous customer. The anonymous electronic bearer instrument, i.e., in the form of a card, permits the bearer to use a remote terminal, to purchase goods through any standard point-of sale device or to withdrawal of currency from an ATM. A customer selected unique bearer instrument identifier, such as a PIN, prohibits unauthorized use, and secures transactions. A bank-hosted central computer system stores data on unique bearer instrument numbers, unique bearer instrument identifiers, monetary balances, and currency codes; accepts initial and incremental deposits of currency from anonymous customers; and processes purchase transactions. The electronic instrument is anonymous, negotiable to the bearer (with knowledge of the unique bearer instrument identifier), secure (without knowledge of the unique bearer instrument identifier), reusable, and performs all the functions of a bank debit card.

### BACKGROUND OF THE INVENTION

1. Field of the Invention

The present invention relates to an anonymous electronic bearer instrument method and apparatus. More specifically, the invention is directed at providing an anonymous electronic bearer instrument, capable of anonymously transacting for currency, goods, and services through remote terminals into the field of electronic financial transaction instruments. Once a unique anonymous card of the subject invention is created, anonymous transactions can be completed at point-of-sale (POS) devices for the purchase of goods and services and at ATM machines to obtain currency and card balance information.

Electronic financial transaction instruments have been in use for some time, dating back at least to credit cards, usually embodied as plastic cards with a magnetic strip containing encoded information. These instruments are in widespread use throughout the world economy and provide certain advantages over cash. One advantage is the ability of a debit card to be a secure instrument, through a personal identification number (PIN) or some other means, providing a way to avoid the loss or theft of cash. Another advantage that an electronic financial instrument has over cash is the small, lightweight embodiment of such instruments, allowing access to large amounts of currency, as opposed to carrying a large amount of cash. Other advantages of electronic financial instruments are that they can keep track of transactions, allowing for review of spending habits and budgeting.

The technology of electronic financial instruments, although beginning with a user-specific credit card, has evolved into a wide array of uses, some more versatile than others. Today, plastic cards with magnetic strips embody electronic financial transaction instruments such as credit and debit cards, “check” cards, secured credit cards, prepaid debit cards, phone cards, rapid transit cards, gasoline cards, and a myriad of other special-purpose uses. These cards all have particular advantages and disadvantages.

In the past, bank/debit cards were only available to customers who had an account at a bank or financial institution, and were not capable of anonymous transactions, due to a direct tie to an individual customer account These cards are and have been available for use in remote terminals (POS devices and ATM machines) connected to the central computer systems of banks. However, despite versatility, these cards have not been a viable option for many people. For instance, some people lack the identification necessary to create an account, such as a social security number, a driver's license, and other forms of identification. Others lack willingness to create bank accounts out of distrust of financial institutions. Many fear that their privacy may be compromised by information collected and dispersed by these institutions, as well as being subject to fees for banking transaction, banking errors, and mishandling of their accounts.

Similar in certain respects to debit cards are automatic credit cards, which are very popular and in widespread use. Credit cards are capable of being used in substitution of cash for purchasing goods and services through a multitude of locations with remote terminals. Credit cards can be used when one does not otherwise have access to cash, or wants to finance a purchase that could not be completed otherwise. However, credit cards with their versatile uses in transactions involving currency, goods, and/or services are also associated with a customer's identity, causing substantial privacy concerns. A common problem associated with many credit cards is the selling of customer purchase information compiled by the credit card company to others offering similar goods and services to those the customer has purchased, resulting in junk mailing and other unwanted solicitations. Another problem associated with credit cards is the problem of releasing personal information in order for the credit card company to conduct a credit review of the applicant. The application and the associated credit review grants the credit card company access to information about the applicant, which the applicant may prefer to keep undisclosed.

Banks presently retain a degree of risk when issuing a credit card. In order to cover broad scale risk and make a profit, banks, which pay three to four percent for money, charge credit card customers interest on unpaid monthly balances of eighteen to twenty percent. From a consumer's perspective a bank credit card, once approved, as opposed to a personal direct purpose loan, provides for unreviewed purchase decisions. In many of these transactions, an objective review would reveal that the purchase decision, although desired, is not wise or affordable. The troubling reality, however, is that human nature and desire drives at least some purchases, over logic, since there is no requirement for present cash or financial review. Purchases are made that create high credit card balances at a twenty percent or more interest rate, and the consumer making minimum payments is locked into an endless cycle of extremely high interest debt. It would therefore be highly desirable to provide a secure electronic bearer instrument where prepayment is a condition precedent to use as a self-regulator of consumer spending decisions.

Notwithstanding certain advantages collectively, bank/debit cards and credit cards, can significantly contribute to a problem of identity theft. There is a multitude of information that is collected and associated with these instruments, and anyone with access to this information, through theft of the instrument or through fraud, is capable of stealing the identity of the instrument's owner. Additionally, e-commerce transactions revolve around the use of debit cards and credit cards, but the security and identity issues over the internet have a strong negative impact on the willingness of many consumers to conduct these transactions. A secure anonymous instrument would greatly benefit the growth of e-commerce, by significantly eliminating identity issues.

Restricted purpose cards, such as prepaid phone cards, which are available to all customers, are not and have not been versatile for uses in remote terminals (POS devices or ATM machines), although they are capable of anonymity in transactions. With anonymity in transactions, there is no tie between a specific customer and a specific transaction, and no customer data can be collected and sold pertaining to a transaction. Restricted purpose cards allow the customer to prepay a specified amount, but they can only be used for their specific purpose, i.e., phone cards for purchasing telephone time.

In many instances consumers simply prefer to use cash. However, cash is not as secure as bank/debit cards and is subject to being lost or stolen. Even in a home environment, many would not consider it wise to have say ten thousand dollars in the home because lack of security.

Notwithstanding the myriad of restricted purpose cards and cards that utilize the existing systems and methods implementing the use of remote terminals (POS devices and ATM machines), there is no presently known way to anonymously conduct electronic financial transactions at remote terminals (POS devices and access ATM machines). Thus, in order to use remote terminals such as POS devices and ATM machines, a customer must have an existing bank/debit or credit card account and an accompanying electronic financial transaction instrument, usually embodied as a plastic card, tied to the account. Additionally, there is no known electronic financial instrument that couples the advantages of restricted purpose cards, such as anonymity and being prepaid, with the versatility and reusability of bank/debit cards and/or credit cards. In this, methods and systems existing in the past are not adequate to address the need for an anonymous electronic bearer instrument capable of anonymously being used in transactions at remote terminals (POS devices and ATM machines).

Accordingly, it would be desirable to provide a method and apparatus for anonymously transacting for currency, goods or services through remote terminals (POS devices and ATM machines) by anonymous customers who have pre-paid amounts of currency on anonymous electronic bearer instruments.

Additionally, it would be highly desirable to provide successful integration of such an instrument into the existing bank debit networks and central computer systems of banks, for example, by means of a remote terminal, which reads and transmits information encoded on the instrument through the bank debit networks to a central computer system of a bank, resulting in an anonymous transaction.

The difficulties, limitations and desires suggested in the preceding are not intended to be exhaustive, but rather are among many which demonstrate that prior art systems and methods for electronic financial transactions at remote terminals will admit to worthwhile improvement.

### OBJECTS OF THE INVENTION

It is, therefore, a general object of the invention to provide a system and method for anonymously transacting for currency, goods or services with an anonymous electronic bearer instrument, which provides customer anonymity in electronic financial transactions conducted through remote terminals, and bypasses the need for a customer setting up an account at a bank or other financial institution in order to conduct electronic financial transactions through remote terminals.

It is another general object of the invention to provide a system and method for anonymously adding funds to an anonymous electronic bearer instrument from a multitude of locations, in a multitude of currencies without having personal access to the instrument.

It is a specific object of the invention to provide a system and method for augmenting and modifying existing standard debit network software currently in use by commercial banks to interface with and process transactions over the debit networks common to the industry by installing additional card company software that maintains and updates as necessary a database specific to anonymous electronic bearer instruments on an existing central computer system of a sponsoring bank, which allows anonymity for customers.

It is another specific object of the invention to provide a system and method for secure electronic financial transactions without using a bank/debit card or credit card.

It is another specific object of the invention to provide a system and method for electronically handling cash securely and anonymously without risk of loss or providing temptation for theft.

It is another specific object of the invention to provide a system and method for keeping bearer (customer) information anonymous by creating a database for anonymous electronic bearer instruments on at least one existing central computer system of a sponsor bank that contains the following four fields: a first field comprising an activated card number, a second field indicating the monetary balance, a third field for a, customer selected, personal identification number (PIN), and a fourth field for a currency code.

It is another specific object of the invention to provide an anonymous electronic bearer instrument that does not require collection of customer data into a database on a central computer system of a sponsor bank.

It is yet another specific object of the invention to provide a system and method for creating an anonymous electronic bearer instrument with a personal identification number (PIN), which is to be selected only by the customer and is not predetermined.

It is yet another specific object of the invention to provide a system and method for anonymously transacting for cash and/or goods and services using remote terminals (POS devices and ATM devices) without a customer having to establish a bank or credit card account.

It is yet another specific object of the invention to provide a system and method for versatile use of anonymous prepaid electronic financial transaction instruments.

It is yet another specific object of the invention to provide a prepaid instrument that is reusable, due to its capability of being anonymously, and capable of being remotely augmented with additional funds.

It is a further object of the invention to provide an anonymous bearer instrument that can be securely used over the internet without risk of identity theft.

### SUMMARY OF THE INVENTION

To achieve at least some of the foregoing objects, the subject invention provides a method for anonymously transacting for at least one of currency, goods or services with an anonymous electronic bearer instrument, which allows for customer anonymity in electronic financial transactions conducted through remote terminals, and bypasses the need for a customer to set up an account at a bank or other financial institution in order to conduct electronic financial transactions.

The present invention uniquely provides a method of anonymously conducting electronic financial transactions, combining the advantages of versatility built into the operation of bank/debit or credit cards with the anonymity and ease of use built into the operation of many pre-paid restricted purpose cards. An anonymous bearer instrument is activated by an anonymous customer exchanging a currency amount in cash, or some other valid means of payment, in a specified amount along with a vendor's fee to a vendor. A currency amount to initiate an active anonymous electronic bearer instrument is sent via a vendor's debit card or credit card swiped through a remote terminal, and an active anonymous electronic bearer instrument is created by the vendor and given to the anonymous customer. The customer then selects a unique bearer instrument identifier, such as a PIN, and inserts it into a remote terminal at the vendor site, which sends the unique bearer instrument identifier, corresponding to a particular anonymous electronic bearer instrument, to a database to secure the instrument. The anonymous electronic bearer instrument can then be used for anonymously transacting for currency, goods, or services through remote terminals, such as point-of-sale (POS) devices and/or an ATM terminal, and anonymously transacting on the internet.

### DRAWINGS

Other objects and advantages of the present invention will become apparent from the following detailed description of preferred embodiments thereof taken in conjunction with the accompanying drawings, wherein:

FIG. 1 illustrates vendor/anonymous customer interaction at a remote terminal;

FIG. 2 is the front side of an anonymous electronic bearer instrument (referred to as an “Insti-Cash card” for purposes of associating a name with the instrument), in accordance with the present invention comprising a plastic or paper card, of size and thickness conforming to the standards for bank debit and/or credit cards with a unique card number and expiration date embossed or printed on the front of the card;

FIG. 3 is the back side of the Insti-Cash card, depicted in FIG. 2, which has been enlarged to illustrate zones for magnetic strip embedded information;

FIG. 4 provides an overview of the total Insti-Cash card anonymous electronic bearer instrument system;

FIG. 5 illustrates a method by which a new Insti-Cash card is activated;

FIG. 6 illustrates how an anonymous customer may add value to the balance of an existing Insti-Cash card at any time from any card vendor location, with or without the physical presence of the Insti-Cash card or the corresponding PIN;

FIG. 7 shows how an Insti-Cash card may be replaced if lost, and the procedure to be followed; and

FIG. 8 illustrates how to use an active Insti-Cash card at a remote terminal (POS device/ATM).

### DETAILED DESCRIPTION

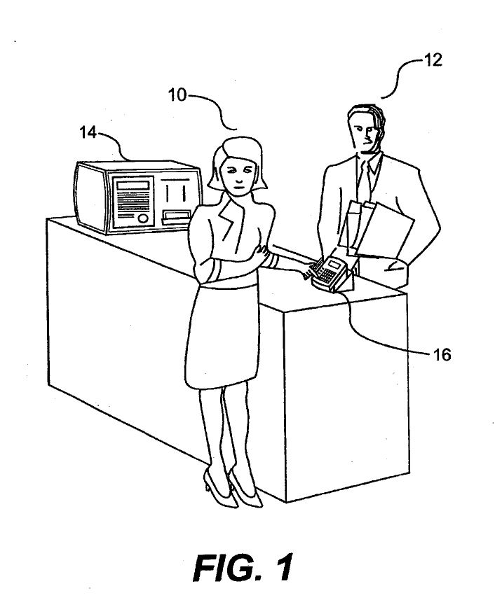

Referring to FIG. 1, a typical transaction is depicted between an anonymous customer 10 and an authorized vendor 12 for either activating a new anonymous bearer instrument (referred to as an “Insti-Cash card” in this description for purposes of associating a name with the instrument), adding to the balance of an active Insti-Cash card, or replacing a lost or stolen Insti-Cash card. Transactions involving activating new Insti-Cash cards or replacing existing Insti-Cash cards require blank Insti-Cash cards, which have not been activated, from an Insti-Cash card dispenser 14. Further, referring to FIG. 1, all of the above transactions involve the use of a remote terminal 16 to transmit information to and from a sponsor bank's central computer system, which a card company (referred to as “Insti-Cash card company” in this description for purposes of associating a name with the card company) account has been established on and Insti-Cash card company software has been loaded.

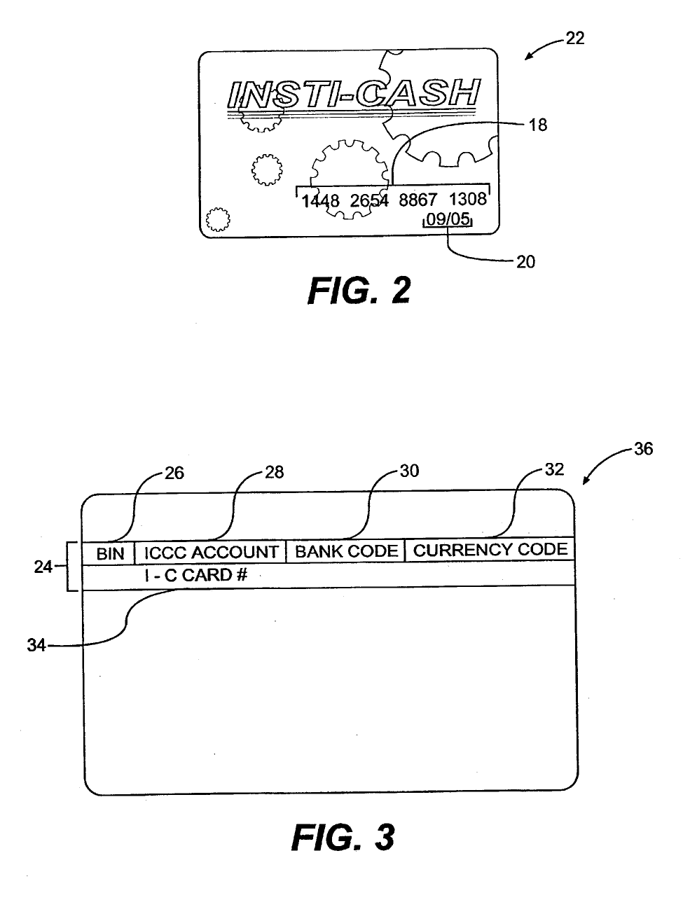

Referring to FIG. 2 and FIG. 3, the front 22 and back 36 of an Insti-Cash card is shown, according to a preferred embodiment of the present invention. The card is preferably composed of plastic or paper, of size and thickness conforming to the standards for bank debit and/or credit cards. Further, referring to FIG. 2, the card includes a unique card number 18 and an expiration date 20 embossed or printed on the front side of the card.

Turning to FIG. 3, a back side 36 of an Insti-Cash card is shown, according to the preferred embodiment of the present invention. Certain information is encoded on a magnetic strip 24 and includes: (1) a Bank Identification Number (BIN) 26 of a sponsoring bank (a national processor so that there is one BIN nationwide); (2) an account number 28 of the Insti-Cash card company at a sponsoring bank; (3) a bank code 30 indicating that an Insti-Cash card is for debit use only; (4) a currency code 32 denoting a currency associated with activating a particular card; and (5) the same card number 34 as embossed or printed on the front side of an Insti-Cash card as shown in FIG. 2.

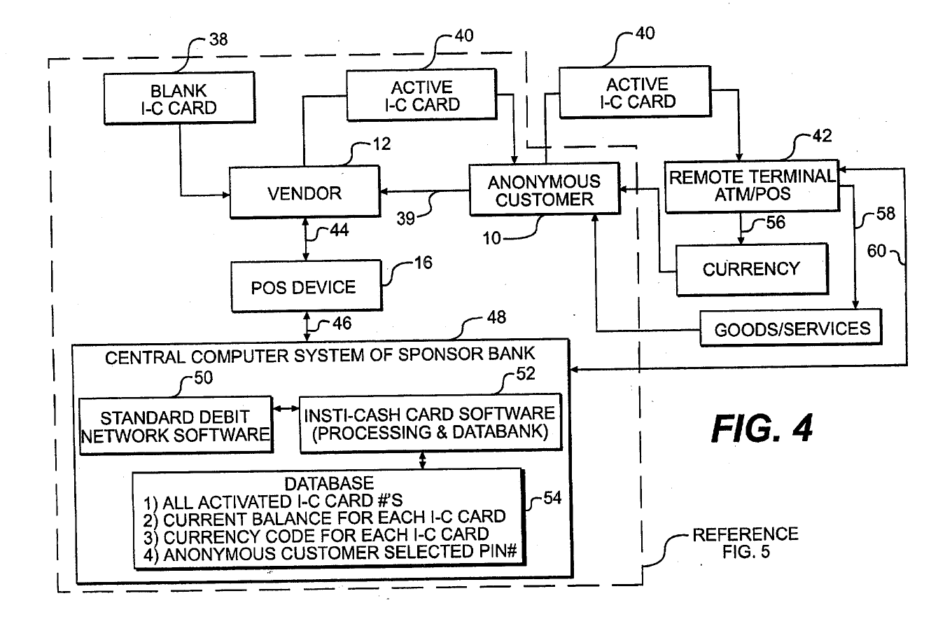

Referring to FIG. 4, input into the system consists of at least one anonymous customer 10, at least one authorized vendor 12, and at least one blank, inactivated Insti-Cash card 38. The anonymous customer 10 transfers to a vendor currency to be input onto an Insti-Cash card, plus a vendor's fee 39 to initiate the system.

The system comprises a remote terminal 16 (POS device) connected by a data transmission line 46 from a vendor, who transmits information to and receives information from the remote terminal 16, to a central computer system of a sponsor bank 48. This central computer system is governed by standard debit network software 50 currently in use by commercial banks to interface with and process transactions over the debit networks common to the industry. Unique to the system is Insti-Cash card company software 52, which augments and modifies the standard debit network software for purposes of interfacing with the subject system. The Insti-Cash card company software maintains and updates as necessary a database 54 which includes: (1) all activated Insti-Cash card numbers, (2) current monetary balance for each card, (3) currency code for each card, and (4) a customer selected anonymous PIN. It is an essential element of this system that the customer information remains anonymous and therefore other information that could be collected or stored is avoided. In certain instances additional information may be collected provided, however, the anonymity of the customer is preserved.

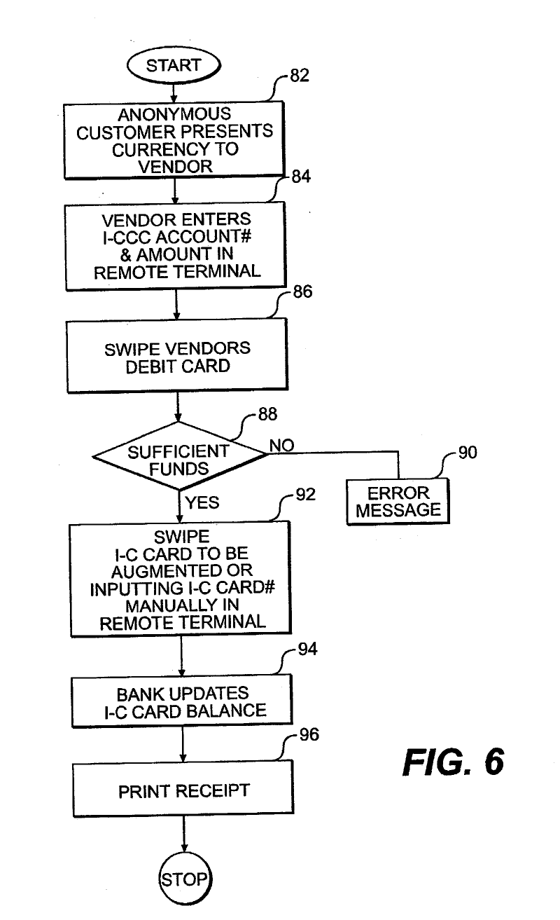

Output from the system is an activated Insti-Cash card 40, with an always-current balance capable of being augmented at the discretion of the Insti-Cash card holder in a manor which will be discussed in detail below in association with FIG. 6. Use of the card at a remote terminal 42 (ATM or POS device) connected by a data transmission line 60 results in ultimate system output of currency through an ATM 56 or goods/services from the POS device 58.

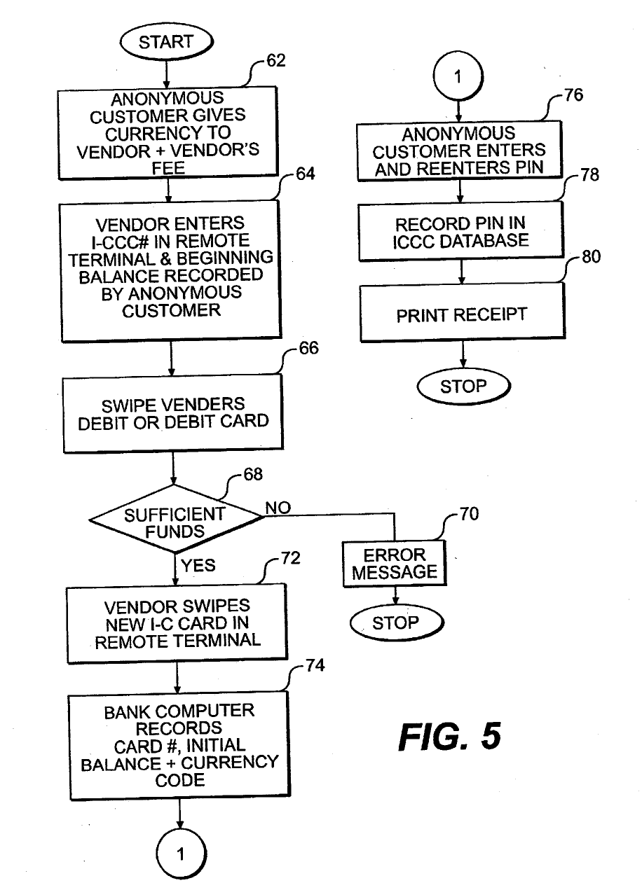

FIG. 5 is a flowchart illustrating how an Insti-Cash card becomes activated by an authorized vendor 12 through a remote terminal 16 at the vendor's site. First, an anonymous customer 10 requests an Insti-Cash card and transfers currency to the vendor 12 in any amount desired for the initial Insti-Cash card balance plus the vendor's fee (note step 62). The vendor then enters an Insti-Cash card company's account number into the remote terminal 14 (POS device) and enters the beginning balance amount as paid by the anonymous customer 10 to vendor 12 (see step 64). Next, the vendor 12 swipes vendor's debit card in the remote terminal 14 (step 66). The vendor's debit card information is sent through data transmission lines to the sponsor bank's central computer system, which analyzes the vendor's card number for significant funds in the vendor's account to be transferred onto the Insti-Cash card company account (step 68). If the vendor has insufficient funds in his bank account to cover the transaction, an error message is sent and the transaction is halted (step 70). If the vendor has sufficient funds, the transaction proceeds by swiping the anonymous customer's new Insti-Cash card in a remote terminal 16 (step 72). The sponsoring bank's central computer system then records the new Insti-Cash card number, the initial monetary balance amount, and the currency code of the initializing currency into the Insti-Cash card company account's database (step 74). The anonymous customer is then prompted to select and enter a user specific and only user known PIN on the keypad of the remote terminal 16 at the vendor's site. The anonymous customer then re-enters the PIN for verification (step 76). The PIN is recorded by the sponsor bank's central computer system onto the Insti-Cash card Company account's database (step 78). Finally, a receipt showing the Insti-Cash card number and monetary balance is printed for the anonymous customer, and the transaction is complete (step 80).

An anonymous customer or some other anonymous person may add currency to an Insti-Cash card's monetary balance at any authorized Insti-Cash card vendor's site without having actual possession of the Insti-Cash card and without having knowledge of the PIN. Referring to FIG. 6, the anonymous customer 10 or some other anonymous person presents currency to a vendor 12 (step 82). The vendor then enters the Insti-Cash card company account number and the currency amount delivered to the vendor to be added into the remote terminal (step 84). Then, the vendor swipes the vendor's debit or credit card though the remote terminal (POS device) (step 86). The vendor's debit or credit card information is sent through the data transmission line to the sponsor bank's central computer system for analysis and to determine if significant funds are available in the vendor's account to be transferred into the Insti-Cash card company account (step 88). If the vendor has insufficient funds to cover the transaction, an error message is sent and the transaction is halted (step 90). If sufficient funds exist in the vendor's account, the transaction continues by either swiping an existing, active Insti-Cash card to be augmented, or by inputting the card number manually if the card is not present into the remote terminal (step 92). The PIN need not be known or entered in the transaction. The sponsor bank's central computer system adds the new amount to the monetary balance of the Insti-Cash card and transmits the updated monetary balance to the vendor's remote terminal (step 94), causing a receipt to be printed with the Insti-Cash card number and the amount added, but not the current balance (step 96).

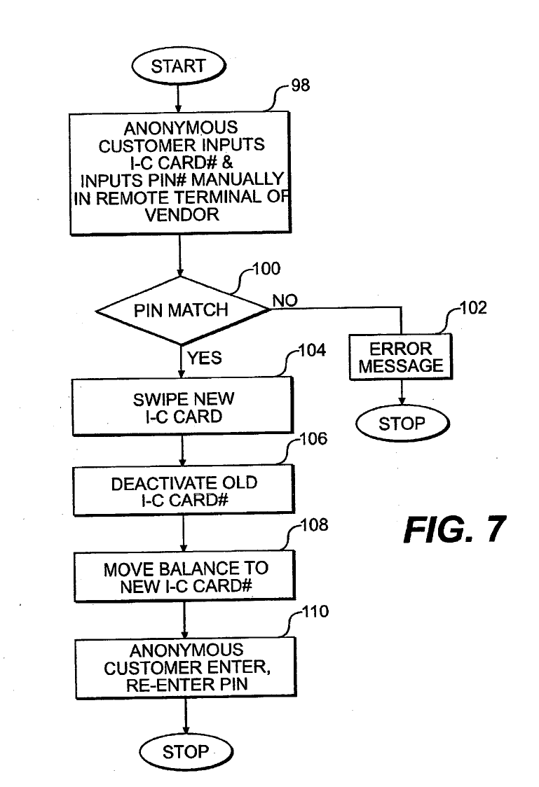

Referring to FIG. 7, a sequence is illustrated of how an anonymous customer 10 may replace a stolen or lost Insti-Cash card. The anonymous customer manually enters the Insti-Cash card number and his/her corresponding unique PIN, using a vendor's remote terminal 16 (POS device) (step 98). The PIN information is sent through the data transmission line to the sponsor bank's central computer system, which determines if the PIN correctly corresponds to the Insti-Cash card number (step 100). If the PIN is incorrectly entered, i.e., not corresponding to the Insti-Cash card, an error message is sent and the transaction is halted (step 102). If the PIN is correctly entered, a new Insti-Cash card, operable to replace the lost or stolen Insti-Cash card, is swiped by the vendor 12 into the remote terminal 16 (step 104). The sponsor bank's central computer system deactivates the lost Insti-Cash card number in the database created by the Insti-Cash card company software on the central computer system of a sponsor bank (step 106), moves the existing balance to the new Insti-Cash card number (step 108), and prompts the anonymous customer to enter and confirm a new PIN corresponding to the new Insti-Cash card number (step 110). Once the new Insti-Cash card's PIN is recorded by the sponsor bank's central computer system, the lost Insti-Cash card becomes deactivated and the new Insti-Cash card is activated for the customer to use.

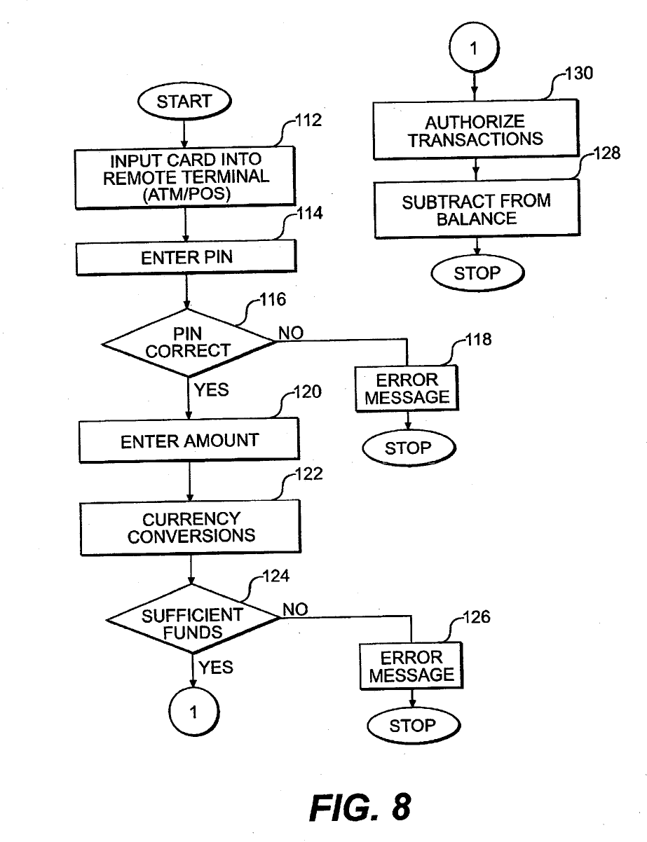

In FIG. 8, an active Insti-Cash card can be used at a remote terminal, to anonymously obtain cash from an ATM machine or to anonymously purchase goods and services through a POS device, which accepts bank debit cards. The anonymous customer 10 inserts an Insti-Cash card into a remote terminal 42 (step 112), and following prompts, enters his/her PIN corresponding to the Insti-Cash card (step 114). The PIN information is sent through the data transmission line to the sponsor bank's central computer system, which determines if the PIN correctly corresponds to the Insti-Cash card (step 116). If the PIN is incorrectly entered, i.e., not corresponding to the Insti-Cash card, an error message is sent and the transaction is halted (step 118). If the PIN is correctly entered, the currency amount to be withdrawn from the monetary balance of the Insti-Cash card is entered by the customer and recorded by the sponsor bank's central computer system (step 120). The remote terminal 42 sends a currency code to the sponsor bank's central computer system, along with the currency amount to be withdrawn from the monetary balance of the Insti-Cash card, through the data transmission line. The currency code corresponding to the Insti-Cash card is compared to the currency code of the remote terminal in the sponsor bank's central computer system and currency conversions take place if necessary (step 122). Then, the sponsor bank's central computer system determines if significant funds are available to be withdrawn from the monetary balance corresponding to the Insti-Cash card number in the database 54 (step 124). If the Insti-Cash card has insufficient funds in the monetary balance to cover the transaction, an error message is sent and the transaction is halted (step 126). If the Insti-Cash card has sufficient funds in the monetary balance to cover the transaction, the transaction continues by sending an authorization message, dispensing currency from the ATM or authorizing the purchase of goods and/or services at a POS device (step 128), and subtracting the currency amount from the monetary balance in the database for the particular card (step 130).

### SUMMARY OF MAJOR ADVANTAGES OF THE INVENTION

After reading and understanding the foregoing description of preferred embodiments of the invention, in conjunction with the illustrative drawings, it will be appreciated that several distinct advantages of the subject system and method for anonymously transacting for currency, goods or services with an anonymous electronic bearer instrument are obtained.

One advantage of the present invention is that it provides anonymity in electronic financial transactions that are otherwise linked to a customer name or customer accounts. The anonymity provided by the anonymous electronic bearer instrument is more versatile than existing pre-paid electronic financial instruments, which are capable of anonymous uses, but are limited to restricted purposes. The versatility of the anonymous electronic bearer instrument is synonymous with that of bank cards, debit cards, and credit cards which are capable of use at remote terminals (POS devices and ATM machines) for electronic financial transactions involving currency, goods, and services. However, the anonymous electronic bearer instrument allows for anonymity in addition to the versatility synonymous with bank cards, debit cards, and credit cards. No customer data is required in activating the instrument, using the instrument, replacing the instrument, or adding funds to the instrument, allowing for complete customer security, even in internet transactions.

Another advantage of the present invention is that it bypasses the need to establish an account, which is not anonymous, at a bank or financial institution in order to conduct electronic financial transactions through remote terminals.

Yet another advantage of the present invention is the anonymous electronic bearer instrument utilizes existing bank debit networks and central computer systems, as well as existing remote terminals to conduct anonymous electronic financial transactions.

A further advantage of the present invention is that the anonymous electronic bearer instrument is easily augmented with finds from any vendor location with only having knowledge of the instrument's unique identification number.

A further advantage of the present invention is the anonymous electronic bearer instrument is easily and anonymously replaced at a vendor location if lost or stolen by providing the anonymous electronic bearer instrument's unique identification number and the corresponding unique bearer instrument identifier, such as a PIN, to deactivate the lost or stolen instrument, and transferring the monetary balance of the lost or stolen instrument to a new instrument which has been obtained through and activated by the vendor, and secured by the anonymous customer selecting a unique bearer instrument identifier to correspond to the new instrument.

In accordance with the foregoing, the present invention provides a system and method for anonymously transacting for currency, goods and services with an anonymous electronic bearer instrument. The present invention allows anonymous customers to conduct electronic financial transactions through remote terminals, and through the internet.

An anonymous electronic bearer instrument is a physical device anonymously providing the ability to conduct electronic financial transactions through remote terminals. The instrument is negotiable to the bearer with knowledge of the unique bearer instrument identifier, such as a PIN, corresponding to the instrument's unique identification number. Alternatively, the instrument is secure without knowledge of the unique bearer instrument identifier corresponding to the instrument's unique identification number. Additionally, the instrument is reusable, and capable of being augmented with additional funds.

A remote terminal is a physical location for conducting electronic financial transactions that is linked by a data transmission line to the bank debit networks and at least one central computer system of a bank. A remote terminal defined more broadly is a location that is used to access and interface with a central network by an outside connection. For purposes of the present invention, a remote terminal can have at least three significant embodiments. The first embodiment is a point-of-sale (POS) device for electronic financial transactions involving goods and/or service. The second embodiment is an automated teller machine (ATM) for electronic financial transactions involving currency. The third embodiment is an internet site that allows for the use of an anonymous electronic bearer instrument, inputting the instrument's unique number and unique bearer instrument identifier, to conduct electronic financial transaction. However, the aforementioned embodiments are not intended to be an exhaustive list of remote terminals capable of being used by anonymous electronic bearer instruments, rather these embodiments are illustrative.

In the present invention a card company establishes a card company account with a sponsor bank, creates a database for maintaining and updating an anonymous electronic bearer instrument, and distributes an inactive anonymous electronic bearer instrument to a vendor.

The present invention is a process of using the card company to create an anonymous electronic bearer instrument capable of providing anonymity to the bearer in electronic financial transactions.

The present invention is a process for activating, previous inactive anonymous electronic bearer instrument to create an active anonymous electronic bearer instrument that is usable in remote terminals.

The present invention is a process for augmenting the monetary balance of an active anonymous electronic bearer instrument to allow for a reusable instrument.

The present invention is a process of replacing an anonymous electronic bearer instrument to deactivate a lost or stolen anonymous electronic bearer instrument, activate a new anonymous electronic bearer instrument, and transfer the monetary balance of the lost or stolen instrument to the new instrument.

The present invention is carrying out the processes according to the present invention through a remote terminal connected by a data transmission line to a central computer system of a sponsor bank.

The present invention includes a central computer system of a sponsor bank capable of carrying out the processes according to the present invention.

In describing the invention, reference has been made to preferred embodiments and illustrative advantages of the invention. Those skilled in the art, however, and familiar with the instant disclosure of the subject invention, may recognize additions, deletions, modifications, substitutions and other changes that fall within the purview of the subject invention.

What is claimed:

1. A method for anonymously transacting for at least one of currency, goods or services with an anonymous bearer instrument, said method comprising the steps of:
in exchange for cash, creating an active anonymous bearer instrument for an anonymous customer;
creating a unique anonymous bearer instrument identifier at a remote terminal; and
using said bearer instrument, anonymously acquiring at least one of currency, goods or services by said anonymous customer with said bearer instrument and said bearer instrument identifier.

2. The method for anonymously transacting for at least one of currency, goods or services with an anonymous bearer instrument as defined in claim 1, wherein said step of using said bearer instrument comprises:
using said bearer instrument in an automatic teller machine and anonymously transacting for currency.

3. The method for anonymously transacting for at least one of currency, goods or services with an anonymous bearer instrument as defined in claim 1, wherein said step of using said bearer instrument comprises:
using said bearer instrument in a point-of-sale device, anonymously transacting for goods and/or services.

4. A method for anonymously transacting for at least one of currency, goods or services with an anonymous bearer instrument as defined in claim 1, wherein said step for creating a unique anonymous bearer instrument identifier comprises the step of:
applying a unique anonymous customer selected personal identification number.

5. The method for anonymously transacting for at least one of currency, goods or services as defined in claim 1, and further comprising the step of:
in exchange for cash, anonymously adding monetary value to said bearer instrument.

6. The method for anonymously transacting for at least one of currency, goods or services as defined in claim 1, and further comprising the steps of:
anonymously replacing said bearer instrument by deactivating said bearer instrument; and
anonymously activating a new bearer instrument for an anonymous customer.

7. The method for anonymously transacting for at least one of currency, goods or services as defined in claim 1, wherein said step of creating a unique anonymous bearer instrument comprises:
creating at least one anonymous customer card having at least one magnetic strip.

8. A method for anonymously transacting for at least one of currency, goods or services with an anonymous bearer instrument, said method comprising the steps of:
in exchange for finds transferred by means other than cash, creating an active anonymous bearer instrument for an anonymous customer; and
creating a unique anonymous bearer instrument identifier at a remote terminal; and
using said bearer instrument, anonymously acquiring at least one of currency, goods or services by said anonymous customer.

9. The method for anonymously transacting for at least one of currency, goods or services with an anonymous bearer instrument as defined in claim 8, wherein said step of using said bearer instrument comprises:
using said bearer instrument in an automatic teller machine and anonymously transacting for currency.

10. The method for anonymously transacting for at least one of currency, goods or services with an anonymous bearer instrument as defined in claim 8, wherein said step of using said bearer instrument comprises:
using said bearer instrument in a point-of-sale device and anonymously transacting for goods and/or services.

11. A method for anonymously transacting for at least one of currency, goods or services with an anonymous bearer instrument as defined in claim 8, said steps of applying a unique anonymous bearer instrument identifier comprises the step of:
applying a unique anonymous customer selected personal identification number.

12. The method for anonymously transacting for at least one of currency, goods or services as defined in claim 8 further comprising the step of:
in exchange for funds transferred by means other than cash, anonymously adding value to said bearer instrument.

13. The method for anonymously transacting for at least one of currency, goods or services as defined in claim 8 further comprising the steps of:
anonymously replacing said bearer instrument by deactivating said bearer instrument; and
anonymously activating a new anonymous bearer instrument for an anonymous customer.

14. The method for anonymously transacting for at least one of currency, goods or services with an anonymous bearer instrument as defined in claim 8, wherein said step of using said bearer instrument comprises:
using said bearer instrument in at least one of an automatic teller machine for anonymously transacting for currency, or a point-of-sale device for anonymously transacting for goods and/or services.

15. A method for anonymously transacting for at least one of currency, goods or services with an anonymous card, said method comprising the steps of:
at a vendor site operable for generating a plurality of unique anonymous cards, generating at least one unique anonymous card encoded and embossed with a unique card number on said card; and
authorizing a plurality of vendors, each with a remote terminal capable of transmitting information to a central computer system to interface with and process transactions over bank debit networks; and
establishing at least one card company account, and at least one card company account number corresponding to said account with at least one commercial bank; and
loading card company software which augments and modifies software used by commercial banks to interface with and process transactions over said bank debit networks onto said central computer system; and
creating a database of anonymous card data on said computer system having a first field for all activated anonymous card numbers, and a second field for current monetary balance for each of said card numbers, and a third field for a personal identification number; and
receiving at said commercial bank at the time of anonymous card purchase, said card company account number, and a monetary balance to be established from a currency amount tendered by an anonymous customer to a vendor of said card from said vendor's remote terminal; and
subsequently receiving at said commercial bank from said remote terminal, an anonymous card number to be activated; and
entering said card number and said monetary balance into said first and second fields, respectively, of said database; and
transmitting a message for said customer to designate a personal identification number, and to verify said personal identification number corresponding to said card number; and
receiving from said remote terminal, said personal identification number corresponding to said card number; and
entering a personal identification number into the third field of said database corresponding to said card number, and activating said card corresponding to said card number; and
subsequently receiving from a second remote terminal, a customer inputted personal identification number, a card number corresponding to said personal identification number, and a currency amount to be withdrawn;
subtracting said currency amount from a monetary balance in said database corresponding to said card number and said personal identification number received from said second remote terminal, and updating said monetary balance in said database;
transmitting to said second remote terminal an authorization message for transferring said currency amount if said currency amount is not greater than said monetary balance; and
transmitting to said second remote terminal an error message denying the transferring of said currency amount if said currency amount is greater than said monetary balance.

16. The method for anonymously transacting for at least one of currency, goods or services as defined in claim 15 further comprising the steps of:
creating a database of anonymous card data on said computer system having a fourth field for a currency code; and
receiving at said commercial bank from said remote terminal, a currency code corresponding to said anonymous card; and
entering said currency code into said fourth field of said database.

17. The method for anonymously transacting for at least one of currency, goods or services as defined in claim 16 further comprising the steps of:
receiving from said second remote terminal, a currency code indicating the currency of said second terminal;
comparing currency code of said second remote terminal to said currency code corresponding to said card number in said database; and
converting said currency amount of said currency from said second remote terminal to currency amount to be determined by said currency code of said card number in said database.

18. The method for anonymously transacting for at least one of currency, goods or services as defined in claim 15 further comprising the steps of:
transmitting an error message to said remote terminal if said vendor has insufficient funds to transfer to said card company account in order to establish said monetary balance; and
transmitting an authorization message to said remote terminal if said vendor has sufficient funds to transfer to said card company in order to establish said monetary balance.

19. The method for anonymously transacting for at least one of currency, goods or services as defined in claim 15 further comprising adding value to said monetary balance according to the steps of:
subsequently receiving from a vendor's remote terminal, said card company account number, a card number, and a currency amount to be added to said monetary balance corresponding to said card number in said database by any person with knowledge of said card number tendering said currency amount to said vendor; and
transmitting an error message to said remote terminal if said vendor has insufficient funds to transfer to said card company account and denying the addition of value to said monetary balance; and
transmitting an authorization message to said remote terminal if said vendor has sufficient funds to transfer to said card company account, allowing said currency amount to be added to said monetary balance and updating said monetary balance in said database.

20. The method for anonymously transacting for at least one of currency, goods or services as defined in claim 19 further comprising the steps of:
creating a database of anonymous card data on said central computer system having a fourth field for a currency code; and
receiving at said commercial bank from said remote terminal, a currency code corresponding to said anonymous card; and
entering said currency code into said fourth field of said database; and
receiving from said remote terminal of said vendor, a currency code indicating the currency of said remote terminal;
comparing currency code of said remote terminal of said vendor to said currency code corresponding to said card number in said database; and
converting said currency amount of said currency from said remote terminal of said vendor to currency amount to be determined by said currency code of said card number in said database.

21. The method for anonymously transacting for at least one of currency, goods or services as defined in claim 15 further comprising replacing cards according to the steps of:
receiving from vendor's remote terminal, said card company account number, card number to be replaced, and customer inputted personal identification number corresponding to said card number to be replaced; and
receiving from said vendor's remote terminal, a new card number; and
entering said new card number, and said new currency code into said first fields of said database; and
transferring monetary balance in said second field of said database from said second field corresponding to said card number to be replaced to said second field corresponding to said new card number in said database, and updating said monetary balance corresponding to said new card number in said second field of said database; and
deactivating said card number to be replaced and corresponding personal identification number; and
transmitting a message for said customer to designate a new personal identification number, and to verify said new personal identification number corresponding to said new card number; and
receiving from said remote terminal, said new personal identification number corresponding to said new card number; and
entering said new personal identification number into the third field of said database corresponding to said new card number, and activating card corresponding to said card number.

22. The method for anonymously transacting for at least one of currency, goods or services as defined in claim 21 further comprising the steps of:
receiving from said vendor's remote terminal, a new currency code corresponding to said new card number; and
entering said new currency code into fourth field of said database.

23. A method for anonymously transacting for at least one of currency, goods or services comprising the steps of:
providing a plurality of cards, each with a magnetic strip capable of being encoded with information, and each with a unique card number encoded onto said cards; and
encoding on the magnetic strip of said cards corresponding to each of said unique anonymous card numbers, a bank identification number, a card company account number, a bank code indicating that said cards are for debit use only, and said unique anonymous card number corresponding to a particular card; and
establishing a plurality of vendors, each with a remote terminal capable of transmitting information to an existing central computer system utilizing software; and
loading card company software, which augments and modifies said software on said central computer system; and
creating a database of anonymous customer data on at least one said central computer system having a first field for all activated anonymous card numbers, a second field for current monetary balance for each of said card numbers, a third field for personal identification number as designate by an anonymous customer to correspond to said card, and a fourth field for currency code of said card numbers; and
loading said bank identification number, said card company account number, and said bank code into said central computer system utilizing said software, allowing said card to interface with and operate in conjunction with said central computer system; and
loading said unique card number, and said currency code into said first and fourth fields of said database through said central computer system.

24. The method for anonymously transacting for at least one of currency, goods or services as defined in claim 23 further comprising the step of:
establishing a plurality of vendors, each with anonymous cards, which are inactivated, and having a capability to activate said cards through a remote terminal if sufficient finds exist in said vendor's account to establish the monetary balance each customer desires on said cards.

25. A card for anonymously transacting for at least one of currency, goods or services comprising:
a card having a generally rectangular shape; and
a magnetic strip applied to said card, encoded with information, allowing for interaction with at least one remote terminal;
a unique number for each card, encoded onto said magnetic strip; and
an expiration date, which corresponds to the date on which said card will become no longer usable.

26. The card for anonymously transacting for at least one of currency, goods or services as defined in claim 25 further comprising:
a magnetic strip embedded in said card, encoded with information, containing a bank identification number, a card company account number, a bank code, and said unique number, allowing for interaction with at least one remote terminal

27. The card for anonymously transacting for at least one of currency, goods or services as defined in claim 26 further comprising:
a magnetic strip embedded in said card, encoded with information, containing a currency code, allowing for currency conversion.

28. The card for anonymously transacting for at least one of currency, goods or services as defined in claim 25 further comprising:
a plastic card having a generally rectangular shape; and
a unique number for each card, encoded and embossed on said card.

29. The card for anonymously transacting for at least one of currency, goods or services as defined in claim 25 further comprising:
a paper card having a generally rectangular shape; and
a unique number for each card, encoded and printed on said card.
